(19) United States
(12) Patent Application Publication
(10) Pub. No.: US 2013/0168522 A1
(43) Pub. Date: Jul. 4, 2013

(54) SUPPORTING LATTICE FRAMEWORK

(71) Applicants: Kamal Daas, Tira (IL); Doron Livnat, Oostvoorne (NL)

(72) Inventors: Kamal Daas, Tira (IL); Doron Livnat, Oostvoorne (NL)

(73) Assignee: PRODELTA INVESTMENTS B.V., Rotterdam (NL)

(21) Appl. No.: 13/695,889

(22) PCT Filed: May 3, 2011
(86) PCT No.: PCT/EP2011/002204

§ 371 Date: Mar. 19, 2013

(30) Foreign Application Priority Data
May 4, 2010 (DE) 20 2010 006 408.2

(51) Int. Cl. F16M 13/02

(52) U.S. Cl. CPC F16M 13/022
USPC 248/354.1

(57) ABSTRACT

The present invention relates to a lattice support structure which is adjustable between an inwardly folded and an outwardly folded state, wherein the lattice support structure has longitudinally extending props, wherein the spacing of at least two of the longitudinally extending props from one another is smaller in the inwardly folded state of the lattice support structure than in the outwardly folded state of the lattice support structure, and wherein at least two of the longitudinally extending props are connected to one another by struts in the outwardly folded state of the lattice support structure, wherein at least one rail is arranged at at least one of the longitudinally extending props, and wherein the struts have means at their region facing the rail, by means of which the struts run on or in the rail, when the spacing of longitudinally extending props from one another changes.

The present invention relates to a lattice support structure which is adjustable between an inwardly folded and an outwardly folded state, wherein the lattice support structure has longitudinally extending props, wherein the spacing of at least two of the longitudinally extending props from one another is smaller in the inwardly folded state of the lattice support structure than in the outwardly folded state of the lattice support structure, and wherein at least two of the longitudinally extending props are connected to one another by struts in the outwardly folded state of the lattice support structure.

So-called lattice support structures are known from the prior art which have longitudinally extending props which are connected to one another by struts which can extend obliquely, for example, in the outwardly folded state of the lattice support structure. In this respect, the arrangement of the struts is solved such that the spacing of the props extending in the longitudinal direction of the lattice support structure can be decreased and increased such that the lattice support structure can be inwardly folded and outwardly folded.

It is the underlying object of the present invention to further develop a lattice support structure of the initially named kind such that it has a comparatively simple design and nevertheless enables a problem free inward folding and outward folding.

This object is achieved by a lattice support structure having the features of claim 1.

Provision is accordingly made that at least one rail is provided at at least one of the longitudinally extending props and in that the struts have means at their region facing the rail by means of which the struts run on or in the rail when the spacing of longitudinally extending props from one another changes.

It is thus the underlying object of the present invention to achieve a relative movement between the longitudinally extending props and the struts in that the struts run on rails on the inward folding and outward folding of the lattice support structure, said rails being arranged indirectly or directly at the longitudinally extending props.

The design of the rails themselves is arbitrary as long as it is ensured that the struts can be moved along the rails. It is, for example, conceivable that the rail or the struts have rolls or rollers on which the respective other part rolls off. A sliding movement or the like is also conceivable, for example.

The struts can, for example, be connected to the rails such that they are admittedly movable relative to the rails, but cannot be lifted off the rails. It is conceivable, for example, that the struts at least partly engage behind the rails so that they can be reliably guided on the rail.

The design of the rail itself is largely arbitrary. It is conceivable to design the rail with a smooth running surface or also with a groove in which a part of the strut runs. The rail can be arranged in or on or at the longitudinally extending prop.

The rails preferably extend in the direction or substantially in the direction of the longitudinally extending props; they can be arranged parallel thereto or also at an acute angle to the longitudinally extending props, with this angle preferably being smaller than 20° and particularly preferably smaller than 10°.

An oblique position of the rails can be required if it has to be prevented that struts arranged adjacent in the inwardly folded state of the lattice support structure would otherwise come into contact or would collide with one another. It can be achieved by an oblique position of the rails that end sections of adjacent struts lie next to one another, for example, in the inwardly folded state of the lattice support structure.

Provision is made in a further embodiment of the invention that the rails have a first region to which the struts are connected when the lattice support structure is in the outwardly folded state and have a second region to which the struts are connected when the lattice support structure is in the inwardly folded state, with the spacing of the first region of the rail from the longitudinally extending prop at which the rail is located being preferably smaller than the spacing of the second region of the rail from this longitudinally extending prop. It is thus conceivable that the spacing of the at least one rail from the longitudinally extending prop is not constant over the length of the rail, but rather increases or decreases.

Provision is made in a further embodiment of the invention that at least two of the longitudinally extending props are connected to one another in the outwardly folded state of the lattice support structure by at least two struts which have at least one region by means of which they run on one or more rails of at least one longitudinally extending prop, wherein the rails or sections of the rail are arranged in opposite directions such that the one of the struts runs on a rail in the first direction on the inward folding of the lattice support structure and the other of the struts runs on a rail in a different direction, preferably an opposite or substantially opposite direction, on the inward folding of the lattice support structure. The direction of movement of the struts or of the strut sections which are connected to the rails can thus be in opposite directions. This not only applies to the inward folding of the lattice support structure, but also to the outward folding procedure.

Provision is made in a further embodiment of the invention that at least two of the longitudinally extending props are connected to one another by at least two struts in the outwardly folded state of the lattice support structure, with the struts being connected to the longitudinally extending props and/or to a section of the at least one rail in the outwardly folded state of the lattice support structure in the same region or in adjacent regions and preferably in the same longitudinal position of the longitudinally extending props. It is thus conceivable that the struts or the strut sections are arranged at the same point or at least at adjacent positions in the outwardly folded state of the lattice support structure, which brings about the advantage that they can be locked by one and the same fastening means such as a pin which is plugged through aligned bores.

It is thus conceivable that at least two of the longitudinally extending props are connected to one another by at least two struts in the outwardly folded state of the lattice support structure, wherein the struts are connected to at least one of the longitudinally extending props and/or to a section of the at least one rail by a common connection, preferably by a common pin connection, in the outwardly folded state of the lattice support structure.

It is thus conceivable that two struts can be released from the longitudinally extending prop by the release or removal of one and the same pin so that said two struts can be moved relative to the longitudinally extending prop on the respective associated rails or rail section. The case is, however, generally also covered by the invention that different locking means such as a plurality of pins or the like are provided to lock a plurality of struts.

Provision is made in a further embodiment of the invention that at least two of the longitudinally extending props are connected to one another by at least two struts in the outwardly folded state of the lattice support structure, with the struts being pivotably connected to at least one of the longitudinally extending props.

These struts can be the same struts which—as stated above—run on rails in a different region, for example in the other end region. It is thus conceivable, for example, that one region of the struts is arranged pivotable, but not movable on rails, at the longitudinally extending props and another region of the struts is movable on rails, as is described in more detail above.

Provision is made in a further embodiment of the invention that further struts are provided which connect two adjacent props or also two non-adjacent props, preferably two of the longitudinally extending props disposed diagonally opposite with one another.

In addition to the above-named struts, further struts can thus be provided which connect the longitudinally extending props to one another.

These further struts can contribute to the further stabilization of the lattice support structure.

It is conceivable that these further struts have one or more joints so that they can be moved into their inwardly folded position on the inward folding of the lattice support structure and can be moved into their outwardly folded, preferably straight-line, position on the outward folding of the lattice support structure.

The above-named struts can/or also the further struts can be spaced apart from one another in the longitudinal direction of the lattice support structure and can be connected to one another by a linkage or the like. It is thus possible to carry out a synchronization of the movement of the struts or an actuation of the entire lattice support structure by means of a linkage.

This applies to the initially named struts as well as also to the further struts which can serve the additional stabilization of the lattice support structure.

Apart from these struts, further struts and strut constructions such as pyramid-like strut constructions or the like can be provided within the space bounded by the props provided that this is advantageous for the stability of the entire lattice support structure.

Provision is made in a further embodiment of the invention that fixing means are arranged at at least one of the longitudinally extending props and have means by which the at least one of the struts can be locked at the fixing means. It is thus possible to take up a torque which occurs on a connection between the longitudinally extending prop and a strut by a further fixing device or to achieve a corresponding relief of the connection between the strut and the longitudinally extending prop.

The present invention furthermore relates to a lattice support structure which is adjustable between an inwardly folded and an outwardly folded state, wherein the lattice support structure has longitudinally extending props, with the spacing of at least two of the longitudinally extending props being smaller in the inwardly folded state of the lattice support structure than in the outwardly folded state of the lattice support structure and with at least two of the longitudinally extending props being connected to one another in the outwardly folded state of the lattice support structure by struts which are preferably pivotably connected directly or indirectly to the longitudinally extending props, and with furthermore one or more prop struts being provided which are pivotably connected to at least one of the struts, on the one hand, and are pivotably connected to at least one of the longitudinally extending props, on the other hand.

The prop struts are thus additionally pivoted on the inward folding and on the outward folding of the lattice support structure, wherein a pivot movement takes place relative to the strut, on the one hand, and a pivot movement takes place relative to the longitudinally extending prop, on the other hand. A particularly simple possibility of the inward folding and outward folding of the lattice support structure results by this embodiment of the invention, wherein no provision is preferably made either in this embodiment or in the initially named embodiment that no longitudinal change of the lattice support structure takes place overall on the inward folding and outward folding.

The prop struts can be arranged spaced apart from the struts at the longitudinally extending props. They are preferably pivotally connected centrally or approximately centrally to the struts. However, this is not absolutely necessary. However, a central region or a region in the central third of the struts is preferred at which the prop struts are pivotably arranged.

Provision is made in a further embodiment of the invention that the lattice support structure of the second embodiment is designed in accordance with the characterizing portion of one of the claims 1 to 10.

Provision is made in a further embodiment of the invention that at least one actuator is provided for inwardly folding and/or outwardly folding the lattice support structure, wherein the at least one actuator can be an integral component of the lattice support structure such as an electric motor or can be designed as an external component. It is conceivable, for example, that one of the props extending in the longitudinal direction is raised by means of a crane, which has the consequence that the entire lattice support structure unfolds independently. As soon as this is the case, it can be locked by suitable means if required.

As stated, it is also conceivable that the lattice support structure itself has one or more actuators for the inward folding and/or outward folding.

These actuators can be designed so that they act, for example, on the struts or strut sections which are connected to the rail or rails and effect the desired relative movement between the rail and the strut. It is also conceivable to provide a central actuator which acts on the entire lattice support structure so that it is folded inwardly or folded outwardly.

Provision is made in a further embodiment of the invention that the lattice support structure can be locked by suitable fixing means such as pins or the like in the inwardly folded state and/or in the outwardly folded state and/or in at least one position lying between these two states. It is possible in this manner also to implement intermediate positions between the inwardly folded state and the outwardly folded state.

The present invention furthermore relates to a lattice support structure construction having at least two of the lattice support structures in accordance with one of the claims 1 to 16, wherein the lattice support structures are connected to one another by one or more struts.

Provision is preferably made that the lattice support structure construction includes lattice support structures arranged next to one another and/or above one another. A two-dimensional construction is thus conceivable in which a plurality of lattice support structures are arranged next to one another or are also arranged above one another. A three-dimensional construction is, however, furthermore conceivable in which a plurality of lattice support structures are arranged next to one another and above one another. A corresponding increase of the payload of the entire construction thereby results.

The present invention finally relates to a crane which is composed of or comprises one or more lattice support structures or lattice support structure constructions in accordance with one of the claims 1 to 18.

Further details and advantages of the invention will be explained in more detail with reference to an embodiment shown in the drawing. There are shown:

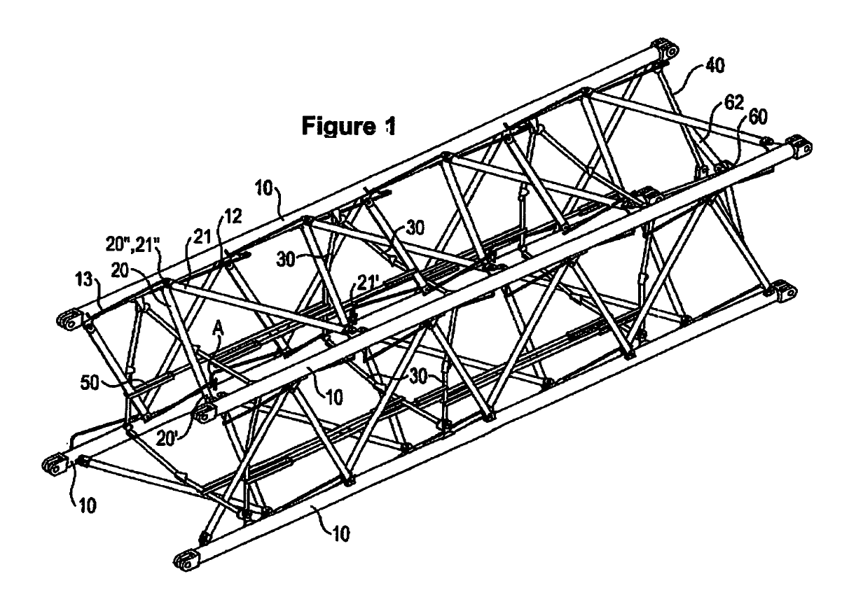

FIG. 1: a perspective representation of a lattice support structure in accordance with the invention in a first embodiment in the outwardly folded state;

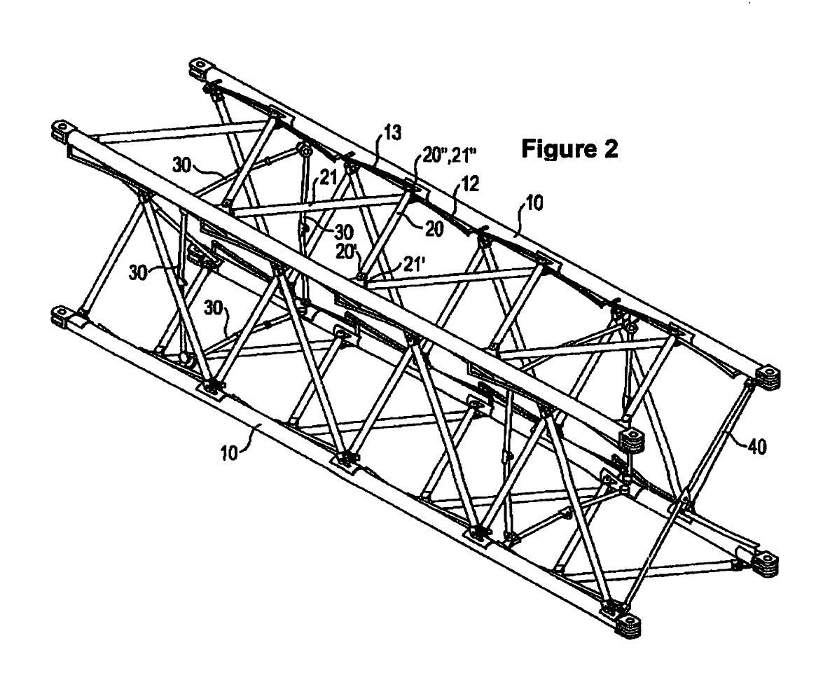

FIG. 2: a perspective representation of a lattice support structure in accordance with the invention in a second embodiment in the outwardly folded state;

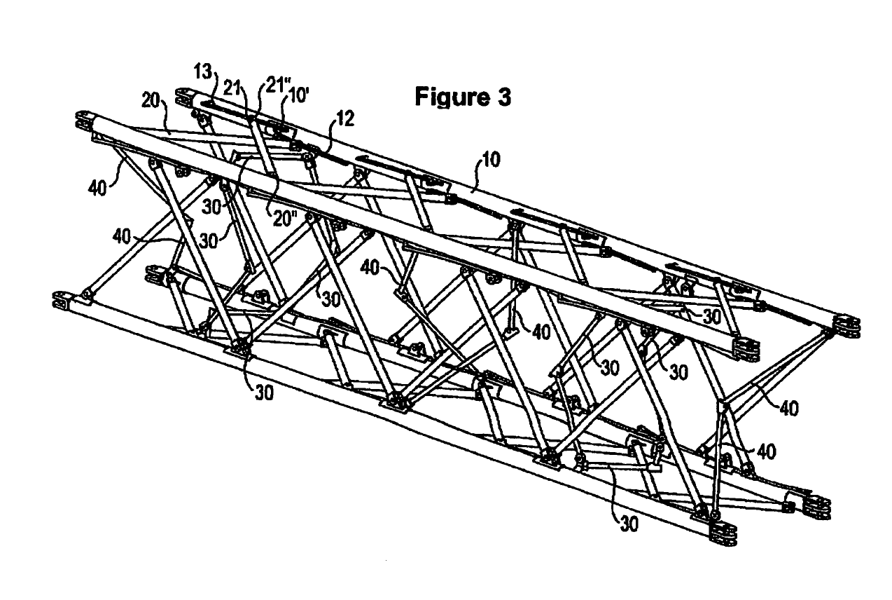

FIG. 3: a perspective representation of a lattice support structure in accordance with the invention in a further embodiment in the partially outwardly folded state; and

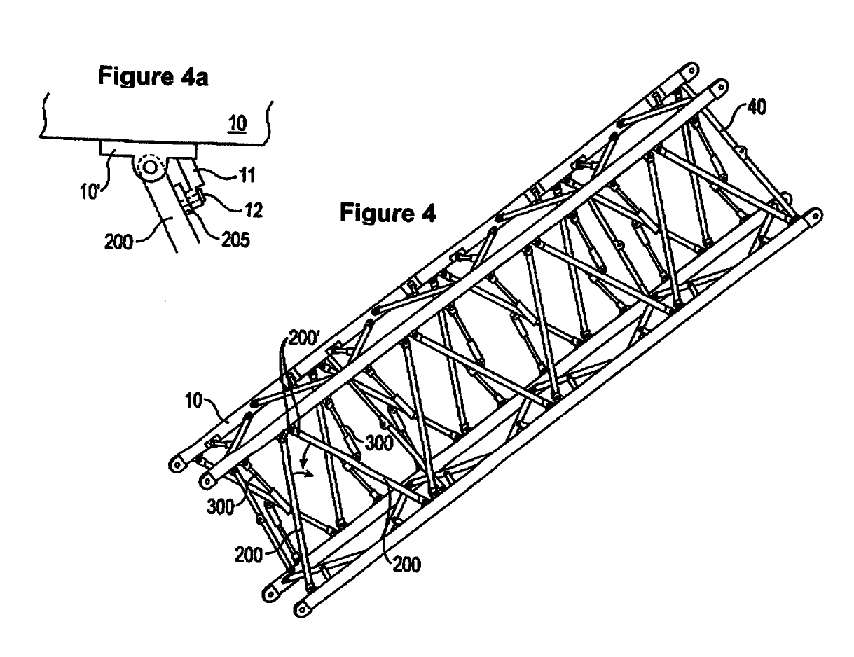

FIG. 4: a perspective representation of a lattice support structure in accordance with the invention in a further embodiment in the outwardly folded state.

A lattice support structure is shown in a first embodiment of the invention in a perspective representation in the outwardly folded state in FIG. 1.

The lattice support structure has four props 10 which extend in the longitudinal direction of the lattice support structure and which are arranged in parallel to one another. Instead of four props 10, more than four or less than four props can generally also be provided.

The props 10 form the outer edges of the lattice support structure which is square or rectangular in cross-section. The respective adjacent longitudinally extending props 10 are connected to one another by struts 20, 21 which include an acute angle between them in the outwardly folded state of the lattice support structure, as can be seen from FIG. 1. The struts 20, 21 are pivotably connected at their one end region 20′, 21′ to one of the props 10 extending in the longitudinal direction. In their other end region 20″, 21″, they are connected to the adjacent prop 10 extending in the longitudinal direction by a pin connection, wherein the pin can be removed manually or also by machine when the lattice support structure should be inwardly folded.

In the outwardly folded state shown in accordance with FIG. 1, the end regions 20″, 21″ of the struts 20, 21 are fixed by a pin at a corresponding lug or bore of the prop 10 extending in the longitudinal direction so that the lattice support structure can be locked overall in the outwardly folded position shown. Rails 12, 13 are located at the props 10 of the lattice support structure extending in the longitudinal direction at the side facing the end regions 20″, 21″, wherein one of the rails 12 is provided for a movement of the strut 20 and a further rail 13 is provided for the movement of the rail 21.

Generally, instead of two separate rails 12, 13, a common rail can also be used for moving the rails 20, 21.

The rails 12, 13 project from the outside of the prop 10 extending in the longitudinal direction and have an inclination, and indeed such that the spacing of the rails 12, 13 from the longitudinally extending prop 10 is smaller in the region in which the struts 20, 21 are located in the outwardly folded state in accordance with FIG. 1 than in the region in which the struts 20, 21 are located in the inwardly folded state.

If the lattice support structure in accordance with FIG. 1 is inwardly folded, the pin connection in the region of the end regions 20″, 21″ of the struts 20, 21 is released so that the struts 20, 21 can be moved with their end regions on the rails 12, 13. In the embodiment shown in accordance with FIG. 1, the strut 20 or its end region 20″ is moved to the right on the rail 12 on the folding together and the strut 21 or its end region 21″ is moved to the left on the rail 13.

In this respect, the respective other end regions 20′, 21′ of the struts 20, 21 remain arranged pivotable at the adjacent prop 10 extending in the longitudinal direction, that is the pivotable connection there is not released on the inward folding and outward folding.

As can further be seen from FIG. 1, the longitudinally extending props 10 are not only connected by the struts 20, 21, but also by further struts 30, 40 which either connect two adjacent props to one another or also two non-adjacent props such as diagonally opposed props.

Struts are, for example, marked by the reference numeral 30 which each connect two adjacent props 10 extending in the longitudinal direction and which each have a joint centrally so that they can likewise be folded up overall on the inward folding of the lattice support structure.

In the state in accordance with FIG. 1 folded apart, the further struts 30 preferably adopt a straight alignment, that is they are stretched in the region of their joint.

It is generally conceivable likewise to lock the further struts 30, for example in that a pin is inserted in the region of the joint as soon as the end position has been reached.

As can further be seen from FIG. 1, the struts 30 form a frame which is spanned within the region which is formed by the longitudinally extending props 10.

A linkage is marked by the reference numeral 50 which respectively connects two struts 30 to one another which are adjacent to one another in the longitudinal direction. This linkage is in each case pivotably connected to the struts 30 and has the effect that the movement of the struts 30 or of the frames formed by them takes place simultaneously or in a coordinated manner when the total lattice support structure is folded inwardly or outwardly.

Fixing means are marked by the reference numeral 60 which ensure that the lattice support structure remains locked in the outwardly folded state.

Alternatively or additionally, the component in accordance with the reference numeral 60 can also be an actuator by means of which the lattice support structure can be folded inwardly and outwardly.

The means 60 or the actuator 60 comprises a central section and forwardly extending arms 62 which in turn have an effect on struts 40 which are connected to the props 10 extending in the longitudinal direction.

If the lattice support structure in accordance with FIG. 1 should be inwardly folded, the connections between the end regions 20″ and 21″ and the prop 10 extending in the longitudinal direction are released in that a pin is removed from the aligned bores which are arranged in the end regions 20″, 21″, on the one hand, and in the prop 10 or in a projection provided there, on the other hand. The bores are preferably aligned in the state of the lattice support structure folded apart so that a problem-free introduction of a pin or of another suitable connections means is possible.

If the pin is removed, the end regions 20″, 21″ of the struts 20, 21 are movable relative to the rails 12, 13 so that the lattice support structure can be inwardly folded. As stated above, this inward folding movement can be effected by the release of fixing means 60 or by activating an actuator 60.

It is likewise generally conceivable to carry out the outward folding of the lattice support structure in that one of the props 10 is raised by means of a crane or of another suitable lifting mechanism, whereby the lattice support structure folds outwardly independently. In this respect, the end regions 20″, 21″ run on the rails 12, 13 into their end positions shown in FIG. 1.

Once the lattice support structure has reached its final position, it can be ensured by locking, for example via the locking means 60, that an unwanted inward folding of the lattice support structure is prevented.

The end regions 20″ and 21″ are locked, as stated, by a pin connection at the prop 10.

Instead of such an externally acting actuator or crane for unfolding the lattice support structure, provision can also be made that the actuator is an integral component of the lattice support structure. It is conceivable, for example, that a force is exerted onto the struts 20, 21 and/or onto their end regions 20″, 21″, for example by an electric motor or the like, which has the effect that the end regions 20″, 21″ are moved into the position shown in FIG. 1. Subsequently, a securing of the struts 20, 21 to the prop 10 can be carried out.

As can further be seen from FIG. 1, the rails 12, 13 are not configured exactly in parallel to the longitudinal direction of the props 10, but rather at least some of them in an acute angle with the props 10. This has the advantage that ends of the struts adjacent in the inwardly folded state of the lattice support structure do not collide with one another, but can rather be arranged next to one another. Such an offset arrangement of the rail ends can be seen, for example, from the position marked with the reference symbol A in FIG. 1.

FIG. 2 shows a further embodiment of a lattice support structure in accordance with the invention whose principle structure corresponds to the lattice support structure in accordance with FIG. 1.

As can also be seen from FIG. 2, rails 12, 13 are arranged at the longitudinally extending props 10 which are passed over in respective opposite directions by the respective end regions 20″, 21″ of the struts 20, 21 on the inward and outward folding of the lattice support structure. As can further be seen from FIG. 2, the rails 12 are seated via foot elements at the external periphery of the props 10, that is are spaced apart from the outer surface of the props 10.

The rails 12, 13 can define a straight path or also a curved path. It is important that the rails 12, 13 are designed so that the lattice support structure can be folded up to a space which is as small as possible.

In another respect, in accordance with FIG. 2, the same components or components of the same function are marked by the same reference numerals as in FIG. 1 so that reference is correspondingly made.

As can further be seen from the Figures, the structure of struts 20, 21 is repeated in the longitudinal direction of the lattice support structure so that a stable construction results overall.

In the embodiments shown, the end regions 20′ and 21′ of the struts 20, 20 are seated at the same level in the longitudinal direction of the props 10 and are there preferably pivotally received by a common connection, in particular by a pin connection.

As can further be seen from FIG. 1 and FIG. 2, the struts 20 extend substantially perpendicular to the longitudinally extending props 10 and the struts 21 at an acute angle relative to the props 10, preferably at an angle of approximately 45°.

FIG. 3 shows a further embodiment, with components of the lattice support structure which are the same or of the same function being provided with the same reference numerals as in FIGS. 1 and 2.

As can be seen from FIG. 3, the lattice support structure is shown in a partially unfolded state. It can be recognized that the end regions 20″ and 21″ of the struts 20, 21 are not arranged in the end regions of the rails 12, 13.

If the lattice support structure is folded further inwardly, starting from the state in accordance with FIG. 3, the end region 21″ of the strut 21 moves further to the left on the rail 13 and the end region 20″ of the strut 20 moves further to the right on the rail 12.

If the lattice support structure is folded further outwardly, starting from the position in accordance with FIG. 3, the opposite movement results until the two end regions 20″, 21″ have moved into their end positions. They are there pinned with lugs 10′ which are arranged in the end region of the rails 12, 13 or at the prop 10 and which have a bore or other locking means to fix the end regions 20″, 21″ of the struts 20, 21.

It is conceivable that a fixing of the struts 20, 21 not only takes place in their outwardly folded and/or inwardly folded position, but also in intermediate positions such as is shown in FIG. 3, for example. Such an intermediate locking can be achieved, for example, in that locking means are provided in the region of the rails 12, 13 and/or in that the struts 20, 21 are connected to one another in a specific position, for example by a pin connection or the like.

FIG. 4 shows a further embodiment of a lattice support structure in accordance with the present invention. In contrast to the embodiments in accordance with FIGS. 1 to 3, in the embodiment in accordance with FIG. 4, no displaceable arrangement of the struts 20, 21 at the props 10 extending in the longitudinal direction is provided. Provision is rather made there that the struts 200 are each provided with prop struts which are pivotably arranged at the struts 200 and are furthermore pivotably arranged at the props 10 extending in the longitudinal direction. On the inward folding of the lattice support structure, bolt connections or the like can be released between the end regions 200′ of the struts and the props 10 extending in the longitudinal direction, for example, whereupon a folding together of the lattice support structure is possible. After the outward folding of the lattice support structure into the position shown in FIG. 4, these pin connections can be reestablished so that the lattice support structure is secured in its outwardly folded position.

As can further be seen from FIG. 4, the prop struts are pivotably connected, on the one hand, to the props 10 extending in the longitudinal direction and are pivotably connected, on the other hand, to a central region of the struts 200.

The struts 200 each connect adjacent props 10 of the lattice support structure and are arranged so that they are connected at an acute angle to the props 10 extending in the longitudinal direction in the outwardly folded state of the lattice support structure.

The arrows shown in FIG. 4 mark the direction of movement of the struts 200 on the inward folding of the lattice support structure.

A further stabilization of the lattice support structure is achieved by the additional prop struts, which has the result of an increase in the payload of the lattice support structure and of the possibility of manufacturing larger lattice support structures.

The above statements with respect to further features of the lattice support structure apply accordingly to the embodiment in accordance with FIG. 4.

FIG. 4a shows a detailed representation of the region in which the struts 200 are connected to the props 10 extending in the longitudinal direction. A holder is marked by reference numeral 11 which is welded to the lug 10′ of the prop 10, for example.

A holding element 205 is likewise arranged, preferably welded, to the strut 200. The holder 11 and the holder 205 have bores which are aligned with one another and which can be passed through by a pin 12. It is possible in this manner to absorb or reduce any torques which may occur, in particular in the region of weld connections, for example between the prop 10 and the lug 10′ and/or between the holder 11 and the lug 10′.

Struts 200 also extend in the embodiment in accordance with FIG. 4 on all sides of the outer surfaces of the lattice support structure, as also applies to the aforesaid embodiments in accordance with FIGS. 1 to 3.

Both the lattice support structures in accordance with FIGS. 1 to 3 and the lattice support structure in accordance with FIG. 4 can be folded together so that no length change results on the folding together.

The lattice support structures in accordance with the present invention can be combined in their end regions with other lattice support structures so that a construction of the desired length can be achieved overall.

There are a variety of areas of use. It is, for example, conceivable to use the lattice support structures as components of a crane, for example for the boom and/or one or more guy supports and/or for the tower or parts of the aforesaid elements of a revolving tower crane, of a mobile crane or of a crane vehicle, etc. It is also conceivable to use the lattice support structure constructions as components of a building, for example of an elevator, for a rescue shaft, for a support construction for bridges, tunnels and the like.

1. A lattice support structure which can be adjusted between an inwardly folded state and an outwardly folded state, wherein the lattice support structure has longitudinally extending props (10), wherein the spacing of at least two of the longitudinally extending props (10) from one another is smaller in the inwardly folded state of the lattice support structure than in the outwardly folded state, and wherein at least two of the longitudinally extending props (10) are connected to one another by struts (20, 21) in the outwardly folded state of the lattice support structure, wherein the at least one rail (12,13) is arranged at least one of the longitudinally extending props (10), and wherein the struts (20, 21) have means at their region facing the rail (12,13), by means of which the struts (20, 21) run on or in the rail (12, 13), when the spacing of longitudinally extending props (10) from one another changes.

2. The lattice support structure in accordance with claim 1, wherein the rails (12, 13) extend in the direction, or substantially in the direction, of the longitudinally extending props (10).

3. The lattice support structure in accordance with claim 1, wherein the rails (12, 13) have a first region to which the struts (20, 21) are connected when the lattice support structure is in the outwardly folded state and have a second region to which the struts (20, 21) are connected when the lattice support structure is in the inwardly folded state, with the spacing of the first region of the rail (12, 13) from the longitudinally extending prop (10) at which the rail (12, 13) is located is preferably smaller than the spacing of the second region of the rail (12,13) from this longitudinally extending prop (10).

4. The lattice support structure in accordance with claim 1, wherein at least two of the longitudinally extending props (10) are connected to one another in the outwardly folded state by at least two struts (20, 21) which each have at least one region by means of which they run on one or more rails (12, 13) of at least one longitudinally extending prop (10), wherein the rails (12, 13) or sections of the rail (12,13) are arranged in opposite directions such that the one of the struts (20) runs on a rail (12, 13) in the first direction on the inward folding of the lattice support structure and the other of the struts (21) runs on a rail (12, 13) in a different direction on the inward folding of the lattice support structure.

5. The lattice support structure in accordance with claim 1, wherein at least two of the longitudinally extending props (10) are connected to one another by at least two struts (20, 21) in the outwardly folded state of the lattice support structure, with the struts (20, 21) being connected to the longitudinally extending props (10) and/or to a section of the at least one rail (12, 13) in the outwardly folded state of the lattice support structure in the same region or in adjacent regions and preferably in the same longitudinal position of the longitudinally extending props (10).

6. The lattice support structure in accordance with claim 1, wherein at least two of the longitudinally extending props (10) are connected to one another by at least two struts (20, 21) in the outwardly folded state of the lattice support structure, with the struts (20, 21) being connected to at least one of the longitudinally extending props (10) and/or to a section of the at least one rail (12, 13) in the outwardly folded state of the lattice support structure by a common connection, preferably by a common pin connection.

7. The lattice support structure in accordance with claim 1, wherein at least two of the longitudinally extending props (10) are connected to one another by at least two struts (20, 21) in the outwardly folded state of the lattice support structure, with the struts (20, 21) being pivotably connected to at least one of the longitudinally extending props (10).

8. The lattice support structure in accordance with claim 1, wherein further struts (30, 40) are provided which connect two adjacent props (10) or also two non-adjacent props to one another, preferably two of the longitudinally extending props lying opposite one another.

9. The lattice support structure in accordance with claim 1, wherein a plurality of the struts (20, 21) or of the further struts (30, 40) are provided which are spaced apart from one another in the longitudinal direction of the lattice support structure and which are connected to one another by a linkage (50).

10. The lattice support structure in accordance with claim 1, wherein a fixing means is arranged at least one of the longitudinally extending props (10) and has means by which at least one of the struts (20, 21) can be locked at the fixing means.

11. A lattice support structure which can be adjusted between an inwardly folded state and in outwardly folded state, wherein the lattice support structure has longitudinally extending props (10), wherein the spacing of at least two of the longitudinally extending props (10) from one another is smaller in the inwardly folded state of the lattice support structure than in the outwardly folded state of the lattice support structure, and wherein at least two of the longitudinally extending props (10) are connected to one another by struts (200) in the outwardly folded state of the lattice support structure which are arranged directly or indirectly at the longitudinally extending props (10), wherein one or more prop struts (300) are provided which are pivotably connected to at least one of the struts (200), on the one hand, and are pivotably connected to at least one of the longitudinally extending props (10), on the other hand.

12. The lattice support structure in accordance with claim 11, wherein the prop struts (300) are arranged spaced apart from the struts (200) at the longitudinally extending props (10).

13. The lattice support structure in accordance with claim 11, wherein the prop struts (300) are pivotally connected approximately centrally to the struts (200).

14. The lattice support structure in accordance with claim 11, further comprising of at least one rail (12,13) arranged at least one of the longitudinally extending props (10), and wherein the struts (200) have means at their region facing the rail (12,13), by means of which the struts (200) run on or in the rail (12, 13), when the spacing of longitudinally extending props (10) from one another changes.

15. The lattice support structure in accordance with claim 11, wherein at least one actuator is provided for inwardly folding and/or outwardly folding the lattice support structure, with the actuator being able to be an integral component of the lattice support structure or being able to be designed as an external component.

16. The lattice support structure in accordance with claim 11, wherein the fixing means is provided by means of which the lattice support structure or the struts can be locked in the inwardly folded state and/or in the outwardly folded state and/or in at least one position lying between these states.

17. A lattice support structure construction having at least two of the lattice support structures in accordance with claim 11, wherein the lattice support structures are connected to one another by one or more struts.

18. The lattice support structure construction in accordance with claim 17, wherein the lattice support structure construction includes lattice support structures arranged next to one another and/or above one another.

19. (canceled)
